(19) United States
(12) Patent Application Publication
(10) Pub. No.: US 2004/0040230 A1
(43) Pub. Date: Mar. 4, 2004

(54) Hurricane shutter system

(76) Inventor: Francis L. Taegar, West Palm Beach, FL (US)

Correspondence Address: Michael S. Neustel, Suite No. 4, 2534 South University Drive, Fargo, ND, 58103, US

(21) Appl. No.: 10/235,369

(22) Filed: Sep. 3, 2002

(51) Int. Cl. E06B 3/26

(52) U.S. Cl. 52/202; 52/506.05; 49/50

(57) ABSTRACT

A hurricane shutter system for providing a permanent storm shutter that is affordable and aesthetically pleasing. The hurricane shutter system includes a pair of brackets, a pair of telescoping arms pivotally attached to the brackets, and a shutter structure attached to the telescoping arms. The shutter structure is comprised of a first side member, a second side member and a plurality of bar members extending between the side members. A plurality of reinforcing members are attached to the bar members. A plurality of securing bolts are securable to the building structure with a pair of corresponding securing tabs securable about the securing bolts for retaining the shutter structure closed upon the window.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to window shutters and more specifically it relates to a hurricane shutter system for providing a permanent storm shutter that is affordable and aesthetically pleasing.

2. Description of the Related Art

Window shutters have been in use for years. Conventional shutters are typically constructed of wood and are attached about the sides of a window. However, conventional window shutters are typically not suitable for usage in violent storms such as hurricanes where high winds can easily damage the windows of a building. A solution to conventional window shutters are protective exterior window covering which are neither permanent nor aesthetically pleasing.

While these devices may be suitable for the particular purpose to which they address, they are not as suitable for providing a permanent storm shutter that is affordable and aesthetically pleasing. Conventional window shutters are not suitable for usage in violent storms.

In these respects, the hurricane shutter system according to the present invention substantially departs from the conventional concepts and designs of the prior art, and in so doing provides an apparatus primarily developed for the purpose of providing a permanent storm shutter that is affordable and aesthetically pleasing.

### BRIEF SUMMARY OF THE INVENTION

In view of the foregoing disadvantages inherent in the known types of shutters now present in the prior art, the present invention provides a new hurricane shutter system construction wherein the same can be utilized for providing a permanent storm shutter that is affordable and aesthetically pleasing.

The general purpose of the present invention, which will be described subsequently in greater detail, is to provide a new hurricane shutter system that has many of the advantages of the shutters mentioned heretofore and many novel features that result in a new hurricane shutter system which is not anticipated, rendered obvious, suggested, or even implied by any of the prior art shutters, either alone or in any combination thereof.

To attain this, the present invention generally comprises a pair of brackets, a pair of telescoping arms pivotally attached to the brackets, and a shutter structure attached to the telescoping arms. The shutter structure is comprised of a first side member, a second side member and a plurality of bar members extending between the side members. A plurality of reinforcing members are attached to the bar members. A plurality of securing bolts are securable to the building structure with a pair of corresponding securing tabs securable about the securing bolts for retaining the shutter structure closed upon the window.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a hurricane shutter system that will overcome the shortcomings of the prior art devices.

A second object is to provide a hurricane shutter system for providing a permanent storm shutter that is affordable and aesthetically pleasing.

Another object is to provide a hurricane shutter system that provides adequate protection to a building structure from storms.

An additional object is to provide a hurricane shutter system that may be comprised of various colors and designs to conform to the building structure's appearance.

A further object is to provide a hurricane shutter system that allows for an individual to see through the window.

Another object is to provide a hurricane shutter system that provides shade to the interior of the building structure thereby reducing air conditioning costs.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front view of the present invention.

FIG. 2 is an upper perspective view of the present invention installed upon a window of a building structure in a closed position.

FIG. 3 is an upper perspective view of the present invention installed upon a window of a building structure in a partially open position.

FIG. 4 is an upper perspective view of the present invention installed upon a window of a building structure in a fully open position.

FIG. 5 is an exploded upper perspective view of the present invention.

FIG. 6 is an upper perspective view of the slat members with respective reinforcing members.

FIG. 7 is a side cutaway view of the present invention.

### DETAILED DESCRIPTION OF THE INVENTION

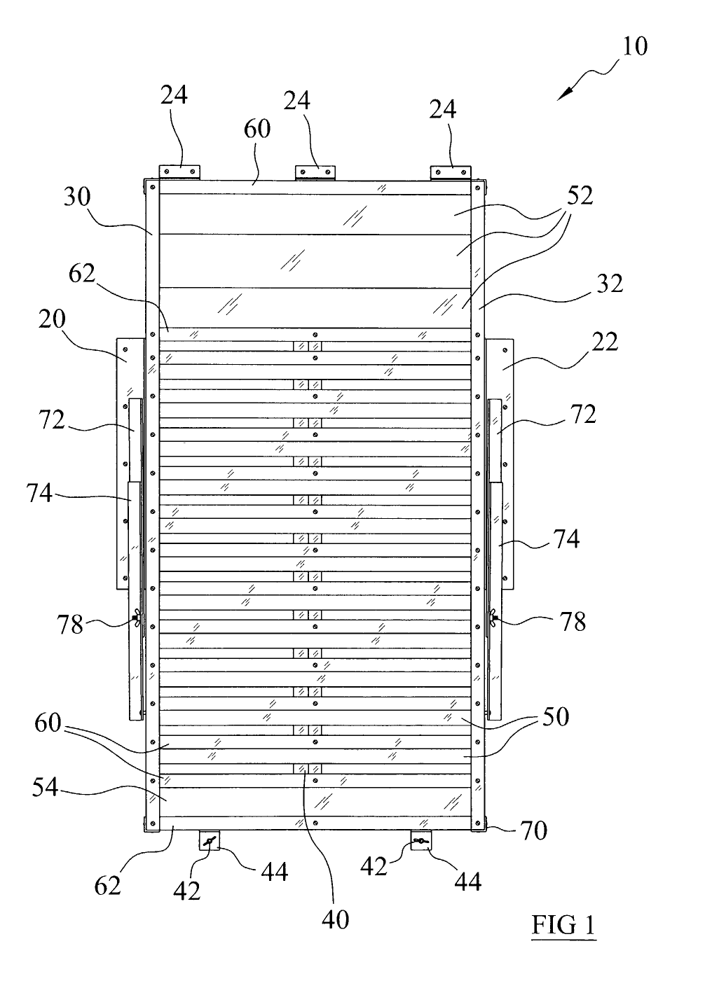

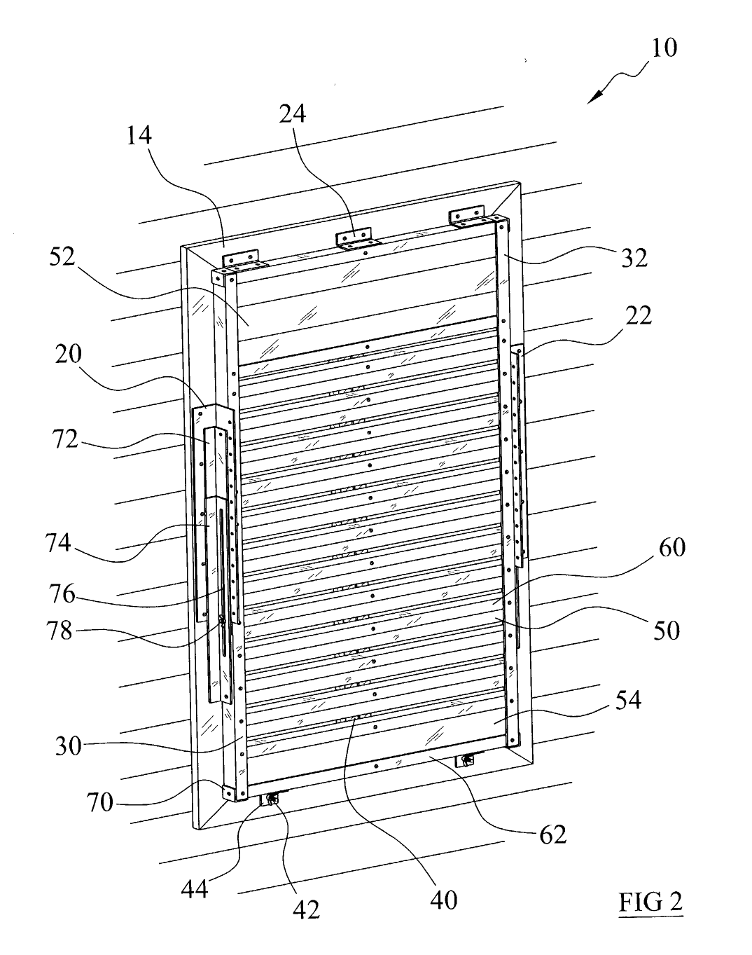

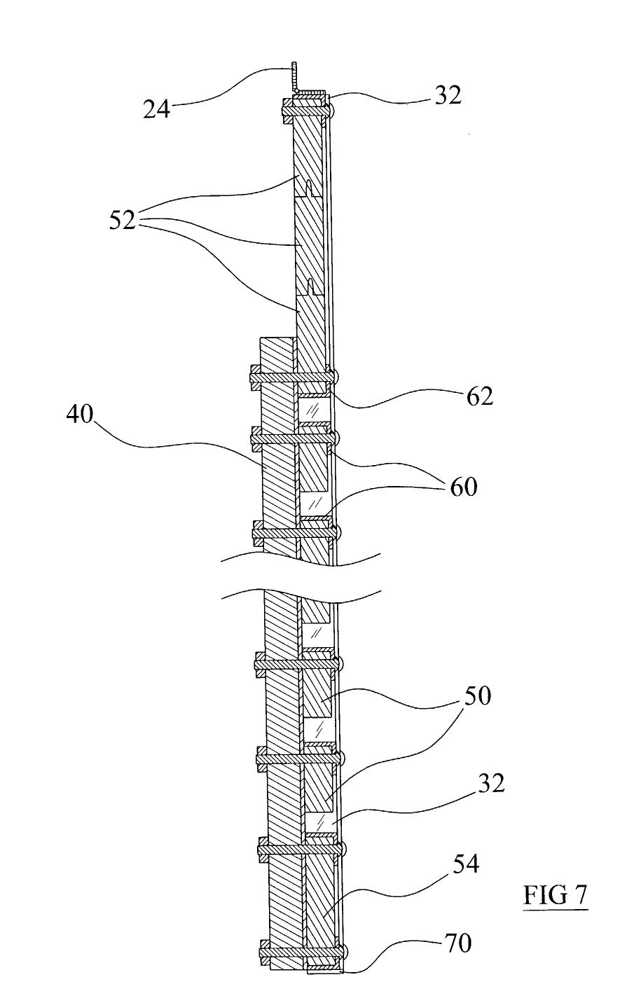

Turning now descriptively to the drawings, in which similar reference characters denote similar elements throughout the several views, FIGS. 1 through 7 illustrate a hurricane shutter system 10, which comprises a pair of brackets 20, 22, a pair of telescoping arms pivotally attached to the brackets 20, 22, and a shutter structure attached to the telescoping arms. The shutter structure is comprised of a first side member 30, a second side member 32 and a plurality of bar members extending between the side members 30, 32. A plurality of reinforcing members 60, 62 are attached to the bar members 50, 52, 54. A plurality of securing bolts 42 are securable to the building structure with a pair of corresponding securing tabs 44 securable about the securing bolts 42 for retaining the shutter structure closed upon the window 12.

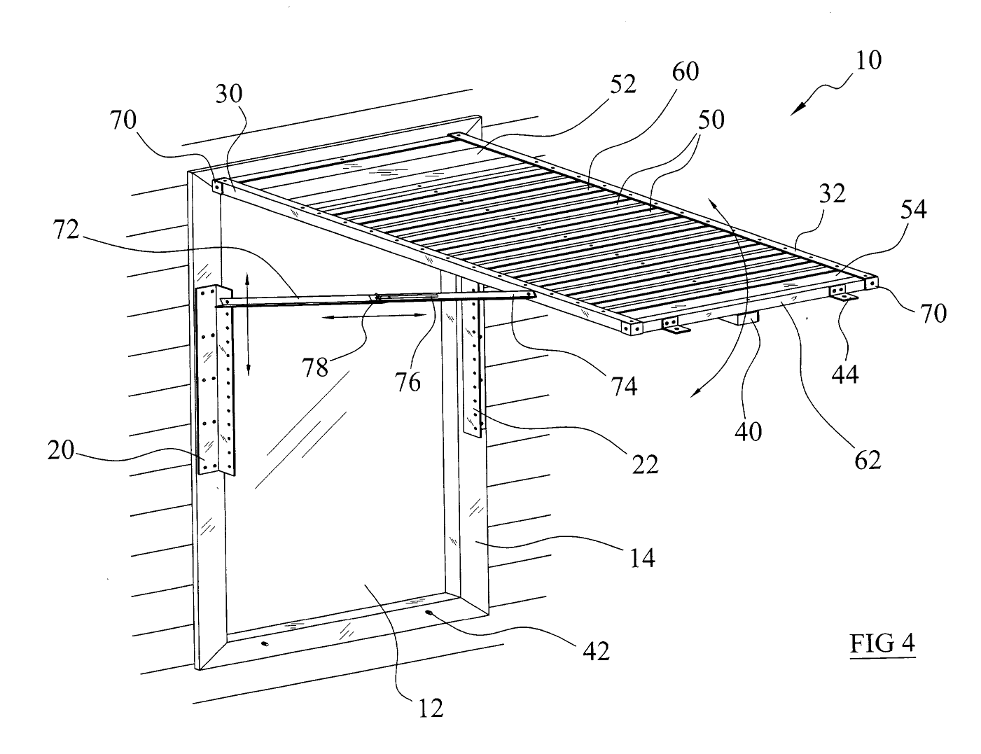

FIG. 4 illustrates the first bracket 20 and the second bracket 22 which are attachable to the exterior trim 14 of the window 12 or to the exterior of the building structure. The brackets 20, 22 are secured to the window 12 or building structure via conventional fasteners such as but not limited to screws, nails, and adhesive. The brackets 20, 22 preferably have a plurality of apertures that selectively receive the telescoping arms as best shown in FIG. 4 of the drawings.

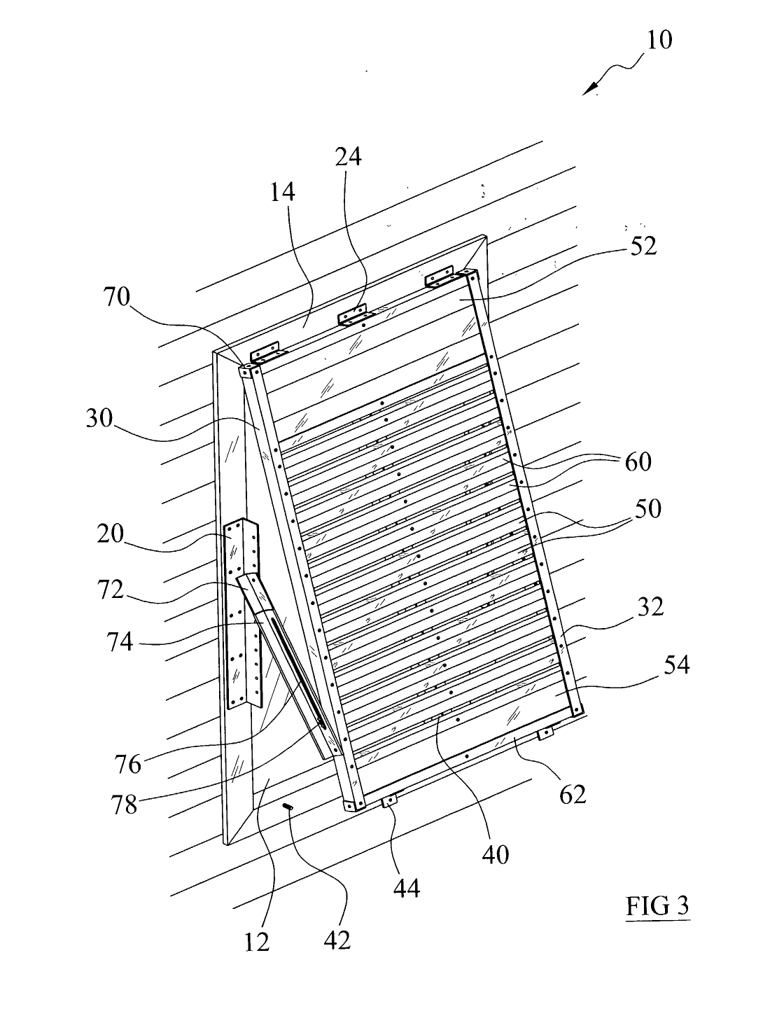

As shown in FIG. 1 of the drawings, a pair of telescoping arms are pivotally attached to a desired location upon the brackets 20, 22 and to the shutter structure. The telescoping arms are each comprised of an inner arm 72 and an outer arm 74. A slot 76 extends into the inner arm 72 and/or the outer arm 74 with a fastener 78 extending through the slot 76 for allowing selective securing of the length of the telescoping arm which allows for maintaining the shutter structure extended away from the window 12 as shown in FIGS. 3 and 4 of the drawings.

As shown in FIGS. 1 through 5 of the drawings, the shutter structure preferably has a generally rectangular shape. However, the shutter structure may be comprised of various shapes and sizes that correspond to the window 12 being protected. The shutter structure may also be comprised of various types of materials such as wood, metal, composite and plastic.

The shutter structure is preferably pivotally attached to the window 12 or building structure by one or more hinges 24 as shown in FIGS. 1 through 3 of the drawings. The shutter structure may be attached to the window 12 by various other hinge structures other than that illustrated in the drawings.

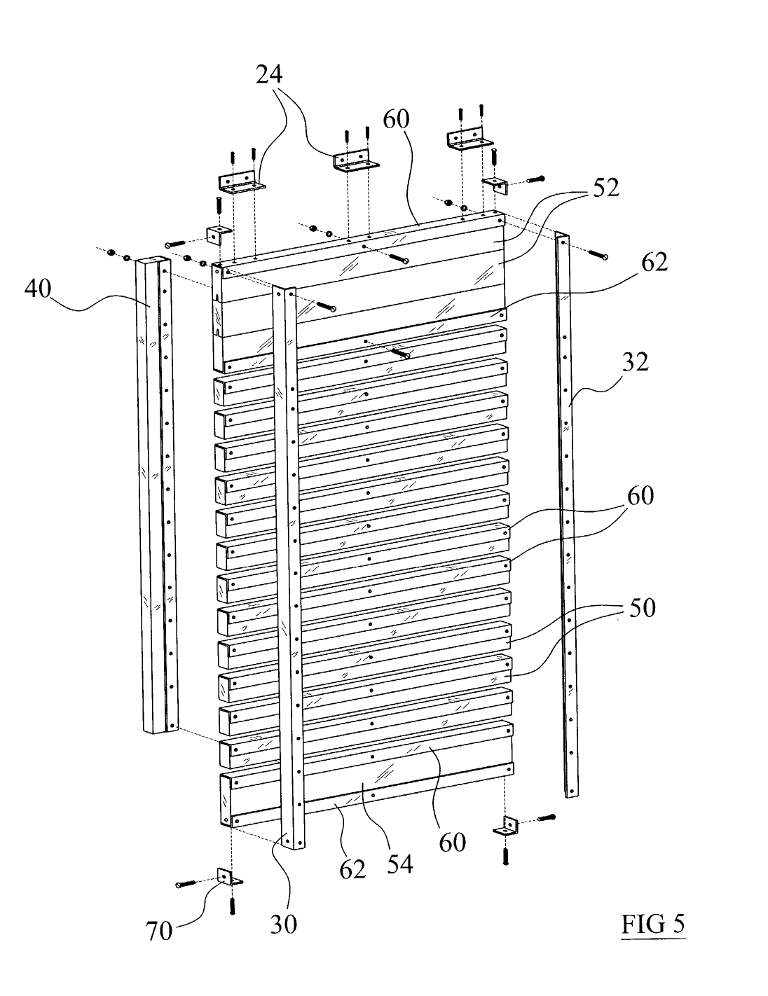

The shutter structure is comprised of a first side member 30 and a second side member 32 with a plurality of bar members 50, 52, 54 extending between thereof. The side members 30, 32 are preferably comprised of an L-shaped cross sectional area with a plurality of apertures within for receiving fasteners to secure the bar members 50, 52, 54 to. A center support member 40 is preferably secured to a rear surface of the bar members 50, 52, 54 to provide additional support to the bar members 50, 52, 54 while being maintained inside of the bar members 50, 52, 54 away from viewing from the exterior of the building structure. The center support member 40 preferably includes a reinforcing member attached to at least one side thereof as shown in FIG. 5 of the drawings.

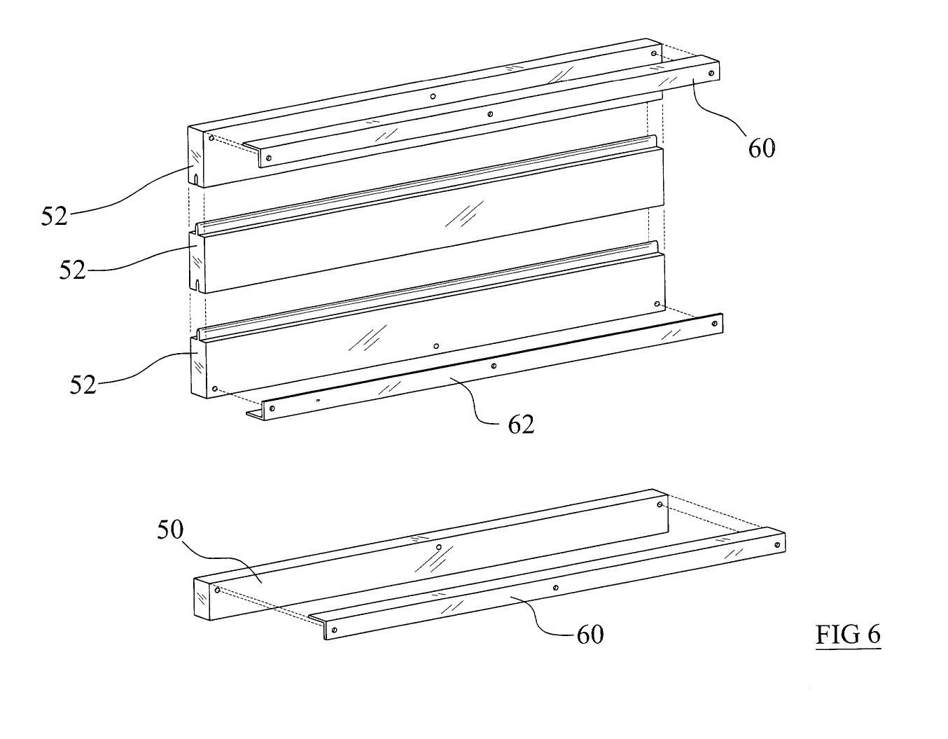

Each of the bar members 50, 52, 54 is elongate and preferably has a flat structure. The upper bar members 52 preferably utilize a tongue and groove structure for interlocking the upper bar members 52 as shown in FIG. 6 of the drawings. An upper reinforcing member 60 is attached to the upper-most of the upper bar members 52 and a lower reinforcing member 62 is attached to the lower-most of the upper bar members 52. The reinforcing members 60, 62 provide additional support to the upper bar members 52. The upper bar members 52 are preferably adjacent one another without any space between thereof thereby providing additional shade to the upper portion of the shutter structure.

Each of the middle bar members 50 is spaced apart from the adjacent middle bar members 50 to define a space which allows for an individual to see through. An upper reinforcing member 60 is preferably attached to an upper edge of the middle bar members 50 for providing additional support to the middle bar members 50. As shown in FIGS. 1, 2, 3 and 5 of the drawings, a lower bar member 54 is provided that has an upper reinforcing member 60 and a lower reinforcing member 62 attached to the upper and lower edges respectively. As best shown in FIG. 5 of the drawings, a plurality of corner brackets 70 are preferably attached to the corners of the shutter structure for providing additional reinforcement to the shutter structure.

As shown in FIG. 4 of the drawings, a plurality of securing bolts 42 are attached to the exterior trim 14 or the building structure adjacent to the lower end of the shutter structure. A corresponding plurality of securing tabs 44 are attached to the lower end of the lower bar member 54 having an aperture which is positionable about the securing bolts 42. A locking member such as a threaded nut or locking pin may be utilized to secure the securing tabs 44 about the securing bolts 42 thereby preventing the opening of the shutter structure from the window 12.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A hurricane shutter system, comprising:
a shutter structure;
an upper hinge pivotally attached to an upper end of said shutter structure; and
a telescoping arm pivotally attached to said shutter structure.

2. The hurricane shutter system of claim 1, wherein said shutter structure is comprised of:
a first side member;
a second side member; and
a plurality of bar members extending between said first side member and said second side member.

3. The hurricane shutter system of claim 2, wherein said plurality of bar members are comprised of:
a plurality of upper bar members adjacent to one another; and
a plurality of middle bar members distally spaced apart.

4. The hurricane shutter system of claim 3, wherein said plurality of bar members further are comprised of a lower bar member.

5. The hurricane shutter system of claim 4, wherein said lower bar member is broader than said middle bar members.

6. The hurricane shutter system of claim 5, including a plurality of upper reinforcing members and a plurality of lower reinforcing members attached to said bar members.

7. The hurricane shutter system of claim 2, including a plurality of upper reinforcing members and a plurality of lower reinforcing members attached to said bar members.

8. The hurricane shutter system of claim 2, including a center support member attached transversely to said bar members.

9. The hurricane shutter system of claim 8, wherein said center support member includes a reinforcing member along a side thereof.

10. The hurricane shutter system of claim 2, including a plurality of corner brackets attached to corners of said shutter structure.

11. A hurricane shutter system, comprising:
a shutter structure;
an upper hinge pivotally attached to an upper end of said shutter structure;
a telescoping arm pivotally attached to said shutter structure;
at least one securing bolt attachable to a building structure; and
at least one securing tab having an aperture within for selectively fitting about said securing bolt when said shutter structure is in a closed position with respect to a window.

12. The hurricane shutter system of claim 1, wherein said shutter structure is comprised of:
a first side member;
a second side member; and
a plurality of bar members extending between said first side member and said second side member.

13. The hurricane shutter system of claim 12, wherein said plurality of bar members are comprised of:
a plurality of upper bar members adjacent to one another; and
a plurality of middle bar members distally spaced apart.

14. The hurricane shutter system of claim 13, wherein said plurality of bar members further are comprised of a lower bar member.

15. The hurricane shutter system of claim 14, wherein said lower bar member is broader than said middle bar members.

16. The hurricane shutter system of claim 15, including a plurality of upper reinforcing members and a plurality of lower reinforcing members attached to said bar members.

17. The hurricane shutter system of claim 12, including a plurality of upper reinforcing members and a plurality of lower reinforcing members attached to said bar members.

18. The hurricane shutter system of claim 12, including a center support member attached transversely to said bar members.

19. The hurricane shutter system of claim 18, wherein said center support member includes a reinforcing member along a side thereof.

20. The hurricane shutter system of claim 12, including a plurality of corner brackets attached to corners of said shutter structure.
